(19) United States
(12) Patent Application Publication
(10) Pub. No.: US 2008/0102770 A1
(43) Pub. Date: May 1, 2008

(54) Method for synchronizing bluetooth accessories in audio applications

(76) Inventors: Timothy P. Froehling, Palatine, IL (US); Seang Y. Chau, San Diego, CA (US)

Correspondence Address: PHILIP H. BURRUS, IV, 460 Grant Street, Atlanta, GA, 30312, US

(21) Appl. No.: 11/553,501

(22) Filed: Oct. 27, 2006

(51) Int. Cl. H04B 1/18

(52) U.S. Cl. 455/187.1

(57) ABSTRACT

A method and apparatus for delivering content wirelessly to a remote wireless device (103) includes withholding content delivery until a link ready acknowledgment has been received. A communication device (201), such as a mobile telephone, includes a client capable of delivering content. For example, an audio client (101) is configured to deliver audio content, which may include music or voice, to a user. When a wireless communication link (210) with a remote wireless device (103), such as a hand-free speakerphone device, is desired, the client requests the wireless communication link from an audio manager (102). The client then withholds content delivery until the audio manager (102) establishes the wireless communication link (210) and delivers a link ready acknowledgement. In so doing, the method and apparatus prevent lost audio.

### BACKGROUND

1. Technical Field

This invention relates generally to electronic devices capable of communication wirelessly with other devices, and more specifically to a method and apparatus for synchronizing content delivery from applications operating within the electronic device with the establishment of communication channels with the other devices.

2. Background Art

Wireless devices are continually evolving. Using mobile telephones as an example, not too long ago, these devices were only able to send and receive voice calls. New developments in technology, however, have greatly expanded the features, services, and applications available for use with mobile telephones. In addition to voice calls, modern mobile telephones are also capable of taking pictures, capturing video, delivering navigational information, transmitting data, browsing the Internet, playing games, and playing music.

Just as mobile telephone technology has progressed, so too has the technology associated with accessory devices. One example of this progress relates to audio accessories. A wired earpiece used to be required to use a mobile telephone in “hands-free” mode. One plugged a wire into a jack on the phone and inserted an earpiece into the ear. A microphone generally dangled near the user's mouth. Now, however, wireless devices such as Bluetooth enabled headsets allow a user to talk in a hands-free mode without the nuisance of wires tethering them to the mobile telephone.

One problem associated with wireless accessories involves the establishment of the wireless communication channel. When an electronic device, such as a mobile telephone or personal computer, wants to establish a wireless communication link with a wireless accessory, latency is involved. The electronic device must identify the wireless accessory and establish the proper communication protocols, each of which takes time. This problem is especially noticeable in the case of a mobile telephone during a call. When a caller switches from normal to hands-free mode, audio may be lost due to the delay that occurs while the mobile telephone establishes an audio connection with the accessory. Lost audio is both frustrating and time consuming for the user. Where, for example, the user is receiving navigational information such as “turn left at Street A; turn right at Street B; turn right at Street C” and misses the phrase “turn left at Street A” due to lost audio, the user may find themselves just as lost.

There is thus a need for a method and apparatus for preventing lost audio during the establishment of wireless communication channels between devices.

### BRIEF DESCRIPTION OF THE DRAWINGS

FIG. 1 illustrates a flow chart of one method of delivering audio content from an electronic device to a remote wireless device in accordance with the invention.

FIG. 2 illustrates an exemplary electronic device and remote wireless device in accordance with one embodiment of the invention.

FIG. 3 illustrates one method of delivering audio content in accordance with embodiments of the invention.

FIG. 4 illustrates one method for obtaining an audio channel with a remote wireless device in accordance with embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to establishing an audio connection with a wireless electronic device. Apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of establishing audio connections and delivering audio content as described herein. The non-processor circuits may include, but are not limited to, memory devices, a radio receiver, a radio transmitter, signal drivers, clock circuits, power source circuits, and user input devices. As such, functions of apparatus components may be interpreted as steps of a method. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

A method and apparatus for temporarily preventing audio content delivery while a wireless audio connection is established is illustrated and described herein. Embodiments of the invention provide the user with a wireless connection which functions as seamlessly as a wired connection, as an audio application within an electronic device refrains from delivering audio content until a wireless connection is established. As such, the user misses no audio while the wireless accessory and electronic device are negotiating the communication channel.

Using Bluetooth as an exemplary wireless protocol, the establishment of a Bluetooth audio connection can take anywhere from several hundred milliseconds to several seconds. This is especially true when the wireless accessory is in a power saving mode. Wireless accessory devices often enter power saving, or “sleep” modes to conserve battery power when not in use.

In one embodiment, the present invention provides an improved handshaking method occurring between an audio application, an audio manager, and a remote device. Specifically, an audio application, such as a music player, navigational content administrator, or voice call manager, upon requesting a wireless communication channel with a wireless device, waits to deliver audio until an audio communication channel is established.

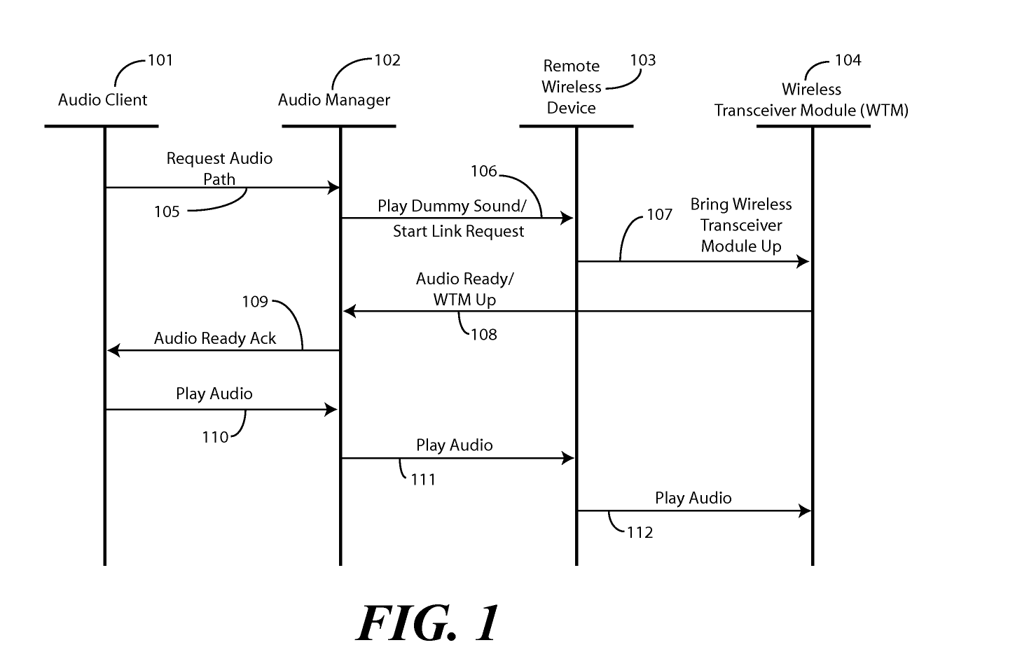

Turning now to FIG. 1, illustrated therein is a flow chart of one embodiment for delivering audio content from an electronic device to a remote wireless device. An audio client 101 requests a wireless audio communication channel with a remote wireless device 103 from an audio manager 102 at segment 105. The audio client 101 is a software program or hardware device operating within the electronic device capable of delivering audio content to a user. For example, in an electronic device capable of playing digital music, the digital music player, which may be software configured to operate in conjunction with a microprocessor, is one example of an audio application. Similarly, in a mobile telephone, the operable application that converts packets of data into aural voice information is another example of an audio client. It will be clear to those of ordinary skill in the art having the benefit of this disclosure that the audio client may include any of a wide variety of software or hardware modules configured to deliver audio to a user.

The audio client 101 requests the wireless audio communication channel from the audio manager 102. The audio manager 102, which functions as a local wireless delivery device, is a hardware or software component within the electronic device that directs audio content from an audio client 101 to one of a variety of audio delivery devices. For example, in a mobile telephone, the audio manager 102 may selectively deliver voice telephone call data to one of a local earpiece, a speakerphone loudspeaker, a jack for a wired accessory, or a wireless port to a remote wireless device. The audio manager 102 functions as an intelligent multiplexer by receiving input from either the audio client 101 or a user by way of a user input and correspondingly delivering audio content to a desired source.

When the audio client 101 requests the wireless audio communication channel with the remote wireless device 103 from the audio manager 102, the audio client 101 refrains from delivering audio content to the audio manager 102. The audio client 101 does this while waiting for the audio manager 102 to deliver a wireless channel availability acknowledgement. By refraining from delivering audio content, the audio client 101 ensures that the user will not miss audio content while the wireless audio communication channel is being established. The audio client 101 may accomplish this in a variety of ways, including but not limited to either buffering content or by delaying an audio content actuation signal.

At segment 106, the audio manager 102 begins the step of establishing a wireless communication link between itself and the remote wireless device 103. The step of establishing a wireless communication link between the audio manager 102 and the remote wireless device 103 may include the step of identifying the remote wireless device 103. Additionally, temporary communication protocols, such as maximum data transmission rate and corresponding power levels, may also need to be negotiated.

In one embodiment, the audio manager 102 does this by playing a dummy sound, such as a status tone, which alerts the remote wireless device 103 and corresponding wireless transceiver module 104 that audio is now being delivered. In another embodiment, the audio manager 102 does this by transmitting an actuation signal to the remote wireless device 103. Where the remote wireless device 103 is in a power saving mode, perhaps to conserve battery power while not in use, segment 106 accomplishes the step of activating the remote wireless device 103 from the power saving mode.

At segment 107, the remote wireless device 103 actuates its wireless transceiver module 104. Where the wireless audio communication channel is a Bluetooth communication link, the remote wireless device 103 may actuate its internal Bluetooth module as the wireless transceiver module 104. The Bluetooth module may communicate by way of a Synchronous Connected Oriented (SCO) link. A SCO link supports a full duplex audio connection. In any event, the wireless transceiver module 104 is capable of establishing an audio path and includes the protocol and other means necessary to do so. The wireless transceiver module 104 may include various firmware and hardware elements, including virtual ports, protocol managers, and synchronization modules. The wireless transceiver module 104, which may also be in a power saving mode, actuates and then transmits a wireless audio channel availability acknowledgement to the audio manager 102 at segment 108.

The audio manager 102 then delivers the wireless audio channel availability acknowledgement to the audio client 101 at segment 109. Upon receiving the wireless audio channel availability acknowledgement, the audio client 101 delivers audio content to the audio manager 102 at segment 110. The audio manager 102, which may serve as nothing more than a pass-through device now that the wireless audio communication channel is established, then delivers the audio content wirelessly to the remote wireless device 103 at segment 111. The remote wireless device 103 passes the audio content to the wireless transceiver module 104 at segment 112, where it is then delivered to the user.

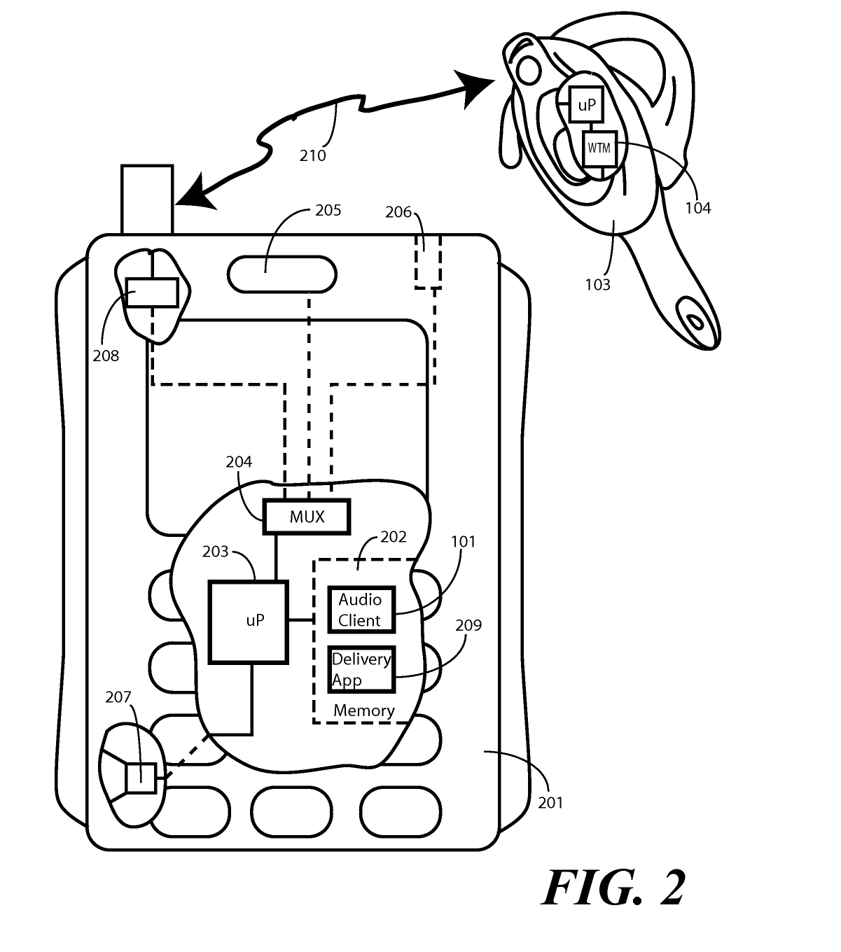

Turning now to FIG. 2, illustrated therein is one embodiment of a communication device 201 and remote wireless device 103 in accordance with embodiments of the invention. While a mobile telephone is used herein as an exemplary communication device, it will be clear to those of ordinary skill in the art having the benefit of this disclosure that the invention is not so limited. Embodiments of the invention may be equally applied to other devices, such as a Bluetooth enabled personal computer (communication device), having a digital music player application (audio client), which is wirelessly in communication with loudspeakers (remote wireless devices), just to illustrate one example.

The communication device 201 includes an audio client 101 configured to transmit audio content. Shown here as an executable software audio delivery application residing in memory 202 and operable with a microprocessor 203, the audio client 101 could equally be a hardware device configured to deliver audio, such as an application specific digital to analog converter.

An audio delivery multiplexer 204 functions as the audio manager for the communication device 201. The audio delivery multiplexer 204 is configured to receive the audio content from the audio client 101 and to deliver the audio content to one of a plurality of devices. Using the illustrative embodiment of FIG. 2, the plurality of devices may include a local earpiece 205, a jack 206 for a wired accessory, a speakerphone loudspeaker 207, or a wireless transceiver 208. The wireless transceiver 208 is configured to receive and transmit audio content wirelessly with a remote source, such as the remote wireless device 103. For example, the wireless transceiver 208 may receive audio content from the audio client 101 by way of the audio delivery multiplexer 204 for delivery to the remote wireless device 103.

A delivery management application 209, shown in FIG. 2 as software operable with the microprocessor 203, is operable with the audio client 101. The delivery management application 209 is configured to delay delivery of the audio content from the audio client 101 to the audio delivery multiplexer 204 until it has established a wireless communication link 210 and has transmitted a link ready acknowledgement.

In one embodiment of the invention, the audio delivery multiplexer 204 has associated therewith a power saving mode. This power saving mode conserves battery power when the communication device 201 is not engaged with the remote wireless device 103. For example, in the exemplary embodiment of a mobile telephone, the phone may not need to communicate with the remote wireless device 103, which may be a Bluetooth headset, when no call is in progress. As such, to maximize talk time, the audio delivery multiplexer 204 may go into a power saving mode where it only periodically acknowledges the remote wireless device 103. Similarly, the wireless transceiver module 104 of the remote wireless device 103 may also go into a power saving, periodic acknowledgement mode. The periodic acknowledgement mode is sometimes referred to as a “sniff” mode.

When either is in a power saving mode, that device must come out of the power saving mode to establish the wireless communication link 210. Thus, in one embodiment, the audio delivery multiplexer 204 has associated therewith a normal mode and a power saving mode, and is further configured to establish the wireless communication link 210 upon exiting the power saving mode. Thus, in this embodiment the audio client 101 is able to request the wireless communication link 210 be established by waking the audio delivery multiplexer 204 from its power saving mode.

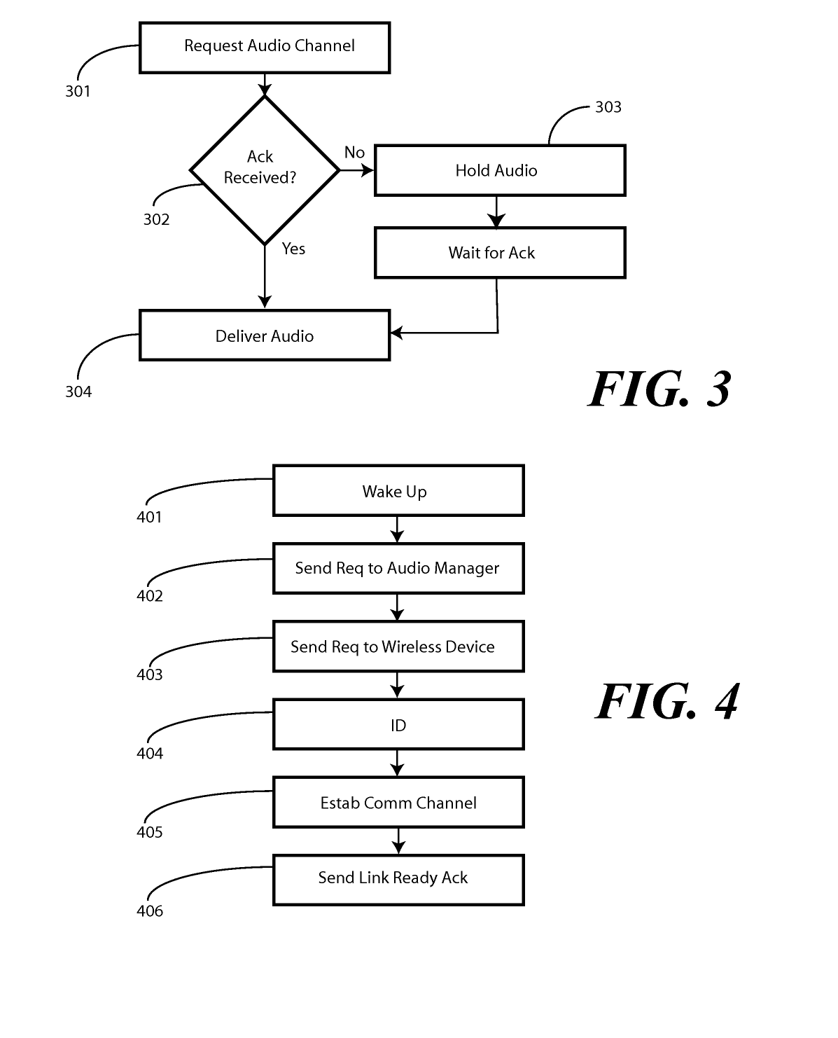

Turning now to FIG. 3, illustrated therein is a general method for a communication device (201) to deliver wirelessly content to a remote wireless device (103) in accordance with one embodiment of the invention. The method presumes the step of providing a client, such as an audio client (101) for delivering content. The method also presumes the step of providing a wireless communication device (such as the audio delivery multiplexer 204) configured to transmit the content upon establishment of a wireless communication link (e.g. wireless communication link 210).

At step 301, the client delivers a request to the wireless communication device for a wireless communication link. At decision 302, the client determines whether a link ready acknowledgement has been received from the wireless communication device. Where it has not, the client withholds delivery of the content at step 303. The client continues this withholding until a link ready acknowledgement is received from the wireless communication device. The wireless communication device transmits the link ready acknowledgement upon establishing a wireless communication link with the remote device.

Where the link ready acknowledgement is received, the client delivers the content at step 304. As noted above, this delivery may include wirelessly transmitting the content to the remote device.

Until now, exemplary content has been audio content. However, it will be clear to those of ordinary skill in the art having the benefit of this disclosure that the invention is not so limited. Other types of content, including video content, may also be delivered in accordance with embodiments of the invention. For example, a wireless satellite receiver box may wirelessly deliver video content to a monitor. Other examples of content include telephonic voice content, musical content, and navigational content. In one embodiment, this content is received by the communication device from a remote server, such as a content store selling musical or video content.

Turning now to FIG. 4, illustrated therein is a more detailed method of establishing the wireless communication link in accordance with one embodiment of the invention. As mentioned above, in one embodiment the wireless communication device includes both an active mode and a power saving mode. Where this is the case, at step 401, the wireless communication device is awakened from a power saving mode. Note that the client may be delivered a power saving mode notification when the wireless communication device enters the power saving mode, thereby alerting the client that any formerly existing wireless communication links have been temporarily terminated.

At step 402, the wireless communication device begins to establish the wireless communication link with the remote device by transmitting a wireless link request (step 403) to the remote device. This may include the transmission of a dummy tone. Alternatively, this may include the transmission of a wireless communication link request data packet.

At step 404, the wireless communication device may perform the optional step of identifying the remote device. This identification step ensures that the content will be transmitted to the proper remote device. At step 405, the wireless communication device establishes a wireless communication link with the remote device. At step 406, the wireless communication device delivers a link ready acknowledgement to the client, indicating that content delivery may now begin.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention.

What is claimed is:

1. A method in an electronic device for delivering audio content, the method comprising the steps of:
requesting from a local wireless delivery device a wireless audio channel with a remote wireless device;
receiving a wireless audio channel availability acknowledgement; and
delivering the audio content only after receipt of the wireless audio channel availability acknowledgement.

2. The method of claim 1, further comprising the step of establishing a wireless communication link between the local wireless delivery device and the remote wireless device.

3. The method of claim 2, wherein the wireless communication link comprises a Bluetooth communication link.

4. The method of claim 2, wherein the wireless communication link comprises a synchronous connection oriented communication link.

5. The method of claim 2, wherein the step of establishing the wireless communication link comprises the steps of identifying the remote wireless device.

6. The method of claim 2, further comprising the step of delivering the audio content wirelessly to the remote wireless device.

7. The method of claim 1, further comprising the step of activating one of the local wireless delivery device or the remote wireless device from a power saving mode.

8. A communication device comprising:
an audio client configured to transmit audio content;
an audio delivery multiplexer configured to receive the audio content from the audio client and deliver the audio content to one of a plurality of devices; and
a delivery management application operating in conjunction with the audio client to deliver the audio content from the audio client to the audio delivery multiplexer only after the audio delivery multiplexer has established a wireless communication link and has transmitted a link ready acknowledgement.

9. The communication device of claim 8, wherein the communication device comprises a mobile telephone.

10. The communication device of claim 9, further comprising a remote wireless device coupled to the communication device by the wireless communication link.

11. The communication device of claim 10, wherein the remote wireless device comprises a Bluetooth headset.

12. The communication device of claim 8, wherein the communication device further comprises a microprocessor, wherein the audio client comprises an executable audio delivery application operable with the microprocessor.

13. The communication device of claim 8, the communication device further comprising a transceiver configured to receive the audio content from a remote source and to deliver the audio content to the audio client.

14. The communication device of claim 8, wherein the audio delivery multiplexer has associated therewith at least a normal mode and a power saving mode, wherein the audio delivery multiplexer is configured to establish the wireless communication link upon exiting the power saving mode.

15. In a communication device, a method of delivering content wirelessly to a remote device, the method comprising the steps of:
providing a client configured to deliver the content;
providing a wireless communication device configured to transmit the content to the remote device upon establishment of a wireless communication link with the remote device, the wireless communication device having at least an active mode and a power saving mode;
waking the wireless communication device from the power saving mode;
delivering a request from the client to the wireless communication device for the wireless communication link;
establishing the wireless communication link with the remote device;
delivering a link ready acknowledgement from the wireless communication device to the client; and
only after the client receives the link ready acknowledgement, delivering the content from the client to the wireless communication device.

16. The method of claim 15, further comprising the step of transmitting the content to the remote device.

17. The method of claim 16, wherein the content comprises audio content.

18. The method of claim 17, wherein the audio content comprises one of telephonic voice content, music content, and navigational content.

19. The method of claim 15, further comprising the step of delivering a power saving mode notification from the wireless communication device to the client upon the wireless communication device entering the power saving mode.

20. The method of claim 15, further comprising the step of receiving the content from a remote content delivery server.
